(19) United States
(12) Patent Application Publication
(10) Pub. No.: US 2005/0121896 A1
(43) Pub. Date: Jun. 9, 2005

(54) Torsional dynamic tuned absorber for vehicle steering system

(76) Inventors: Robert Bonhard, Milford, MI (US); Joe Bakaj, Hiroshima (JP)

Correspondence Address: FORD GLOBAL TECHNOLOGIES, LLC., SUITE 600 - PARKLANE TOWERS EAST, ONE PARKLANE BLVD., DEARBORN, MI, 48126, US

(21) Appl. No.: 10/727,437

(22) Filed: Dec. 4, 2003

(51) Int. Cl. B62D 1/16

(52) U.S. Cl. 280/779

(57) ABSTRACT

A vibration absorber for a vehicle steering system that suppresses torsional vibrations that would otherwise be felt by a driver holding the steering wheel. At least two energy absorbing units are mounted to a steering shaft at locations equidistant from the shaft's axis of rotation. The energy absorbing units may be attached to the spokes of the steering wheel, and are preferably located at diametrically opposite positions on the steering wheel so that they do not adversely affect the balance of the wheel as it is turned. Each energy absorbing unit comprises a mass supported for reciprocal movement along a path of movement perpendicular to a radius of the steering shaft and at least one kinetic energy absorption device acting on the mass along the path of movement. A case houses the mass and kinetic energy absorption device, and a rod is supported at either end by the case and passes through a hole in the mass to guide the mass along the path of movement. The kinetic energy absorption device preferably comprises two coil springs, one located on either side of the mass and encircling the rod. Secondary springs are disposed on opposite sides of the mass along the path of movement and are spaced from the mass by a distance such that the mass contacts the secondary springs when the mass has moved a predetermined distance from a neutral position. The secondary springs serve as travel stops and apply a progressing centering force to the mass when it nears the limits of its movement, thereby producing a dual-rate spring effect to improve the vibration absorbing performance of the absorber units.

### FIELD OF THE INVENTION

The invention relates to steering systems of automotive vehicles, and more particularly to a dynamic tuned absorber to reduce or eliminate torsional vibrations of the steering linkage that would otherwise be transferred through the steering wheel to a driver of the vehicle.

### BACKGROUND OF THE INVENTION

The manufacturers of automotive vehicles are continually pursuing ways to improve customer satisfaction by decreasing the amount of noise, vibration, and harshness (NVH) experienced by the driver and other occupants of a vehicle while it is being driven. One common source of NVH is the interface between the vehicle tires and the road, with vibrations being transmitted through the vehicle suspension and steering systems to the driver though the steering wheel. A torsional vibration of the steering wheel caused by these suspension/road interactions is commonly referred to as “nibble.” Nibble is typically most noticeable in a vehicle traveling at approximately 60-80 mph, and may be made worse by uneven tire wear or inflation.

Conventionally known attempts to reduce nibble include elements that utilize internal friction to damp unwanted vibrations. Such friction vibration-absorbing elements are generally placed at locations along the path of propagation of the vibrations. Such elements may include bushings made of elastomeric materials. U.S. Pat. No. 6,164,689 discloses a vibration absorbing apparatus for a steering wheel having a passenger protection airbag resiliently mounted to the wheel in a manner that allows the airbag to serve as a mass damper. This vibration damper is not effective in reducing torsional vibrations. In the field of power transmission devices, it is known to provide torsional vibration dampers. For example, U.S. Pat. No. 4,160,390 discloses a viscous vibration damper having a hub attachable to a shaft (such as an engine crank shaft) and an annular inertia disc encased in a housing and surrounded by a silicone fluid to provide viscous damping as the inertia disc rotates relative to the hub and housing. The inertia disc is also connected to the hub by coil springs to allow the damping to be tuned as desired.

U.S. Pat. No. 6,402,622 discloses a torsional vibration damper for taking up rotary shocks between two parts rotatable relative to one another. Helical compression springs are oriented in a circumferential direction between the two rotatable parts.

### SUMMARY OF THE INVENTION

The present invention provides a dynamic vibration absorber for a vehicle steering system that suppresses torsional vibrations that originate in the vehicle's suspension system, propagate through the steering shaft, and would otherwise be felt by a driver holding the steering wheel. The invention comprises at least two dynamic energy absorbing units mounted to the steering shaft at locations equidistant from the shaft's axis of rotation. Each dynamic energy absorbing unit comprises a mass supported for reciprocal movement along a path of movement perpendicular to a radius of the steering shaft and at least one kinetic energy absorption device acting on the mass to return it to a neutral position. The energy absorbing units are free to oscillate independently of one another and have dynamic characteristics such that they absorb torsional vibrations experienced by the steering shaft.

According to a preferred embodiment of the invention, the dynamic energy absorbing units are mounted to the steering wheel. The dynamic energy absorbing units are relatively small and light in weight, and may be attached to the spokes of the steering wheel. They are preferably located at diametrically opposite positions on the steering wheel so that they do not adversely affect the balance of the wheel as it is turned.

Also in the preferred embodiment, each dynamic energy absorbing unit comprises a case that houses the mass and kinetic energy absorption device, and a rod supported at either end by the case and passing through a hole in the mass to guide the mass along the path of movement. The kinetic energy absorption device preferably comprises one or more coil springs located on either side of the mass. The springs may encircle the rod.

According to another feature of the invention, secondary springs are disposed on opposite sides of the mass along the path of movement and are spaced from the mass by a distance such that the mass contacts the secondary springs when the mass has moved a predetermined distance from a neutral position. The secondary springs serve as travel stops, cushioning the mass rather than allowing it to bump against the inside of the case, thereby reducing unwanted noise and vibration. Further, the secondary springs apply a progressing centering force to the mass when it nears the limits of its movement, thereby producing a dual-rate spring effect to improve the vibration dynamic energy absorbing performance of the vibration absorber units. The secondary springs may be foam pads secured to the inner surface of the case with adhesive.

Other features and advantages of the invention will become apparent upon review of the following specification.

### BRIEF DESCRIPTION OF THE DRAWINGS

FIG. 1 is a schematic view of an automotive vehicle steering system and suspension system.

FIG. 2 is a perspective view of a steering wheel frame with dynamic energy absorbing units according to the present invention attached to spokes of the wheel.

FIG. 3 is an exploded view of the dynamic energy absorbing unit of FIG. 2.

FIG. 4 is a cross-sectional view taken along line 4-4 of FIG. 3.

FIG. 5 is a cross-sectional view taken along line 5-5 of FIG. 3.

FIG. 6 is a schematic view of an alternative embodiment of a dynamic energy absorbing unit according to the present invention.

FIG. 7 is a partial view of a third embodiment of a dynamic energy absorbing unit according to the present invention.

### DETAILED DESCRIPTION OF THE PREFERRED EMBODIMENT

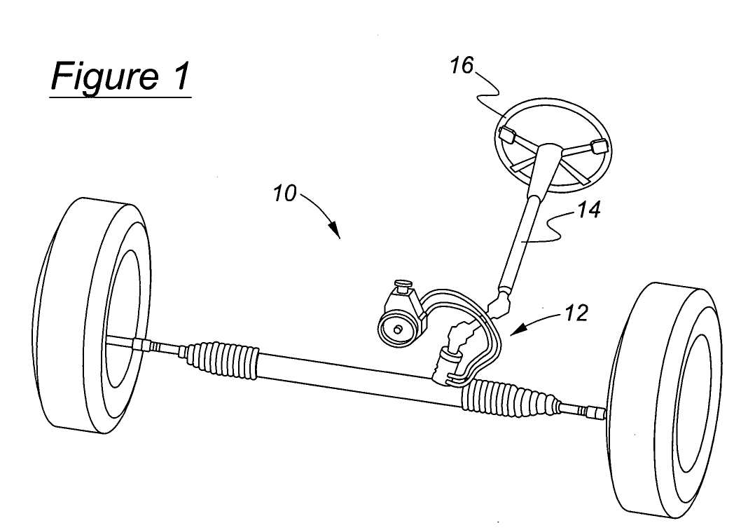

As is depicted schematically in FIG. 1, an automotive vehicle has a steering system generally indicated at 10. Steering system 10 comprises a steering gear 12, which may be of any appropriate powered or un-powered type, such as rack-and-pinion or recirculating ball. As is well known in the art, a steering shaft 14 is rotatable about an axis to apply steering commands to the steering gear and has a steering wheel 16 at its upper end in the passenger compartment. Steering wheel 16 may include a driver protection airbag (not shown), and may also include buttons or switches (not shown) serving as controls for vehicle systems such as a cruise control system and/or an audio system, in a manner well known in the art.

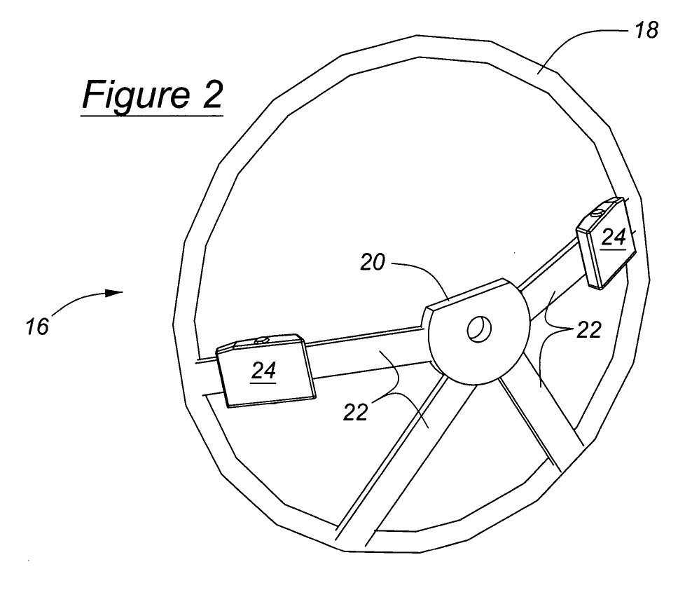

Referring now to FIG. 2, steering wheel 16 is shown with the airbag and other trim components removed to expose a frame comprising a generally circular rim 18, a central hub 20 for attachment to the steering shaft 14, and a plurality of spokes 22 that extend generally radially between the rim 18 and the hub 20. Dynamic energy absorbing units 24 according to the present invention are attached to spokes 22 at two locations.

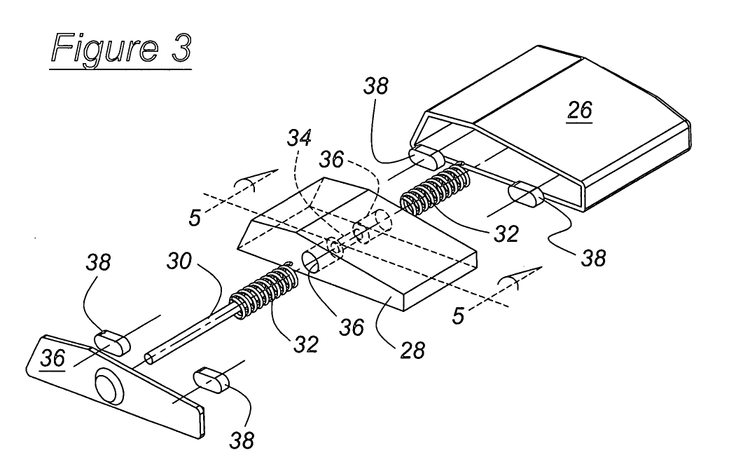

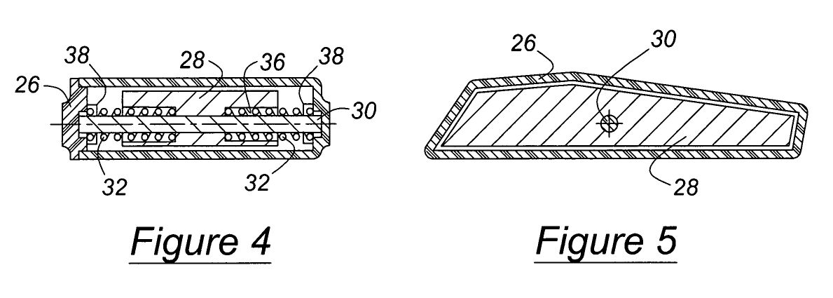

Referring to FIGS. 3 and 4, each dynamic energy absorbing unit comprises a case 26 containing a mass 28, a guide rod 30, and first and second coil springs 32. Case 26 is preferably made of a plastic material and may be fabricated in two or more pieces for ease of manufacturing and assembly. Guide rod 30 extends across the hollow interior of case 26 and is supported at opposite ends by holes, recesses or other positioning means disposed on the case 26. The, overall size and shape of the dynamic energy absorbing units 24 shown is exemplary only, as these parameters will vary depending upon the packaging requirements of a particular steering wheel installation.

Guide rod 30 passes through a hole 34 formed in mass 28 such that the mass 28 is able to slide reciprocally along the guide rod. Coil springs 32 concentrically surround guide rod 30 on opposite sides of mass 28. Inner ends of the springs 32 are preferably retained in counter bores 36 formed in the mass 28, and outer ends of the springs are preferably retained by pins or other locating means (not shown) on case 26. The compression forces of the two of coil springs 32 are balanced to maintain the mass at a neutral position under static conditions. The neutral position is preferably at or near the center of the range of motion of mass 28.

A friction-reducing treatment may be applied to some or all of the exterior of mass 28 and/or the interior of case 26 to promote unimpeded movement of the mass relative to rod and the case. For example, a thin layer of flocking material made of a polyester/cellulose blend applied to the surface of mass 28 has been found to be effective in reducing friction between case 26 and the mass 28.

One or more secondary springs 38 are attached to the inner surface of case 26 adjacent either end of rod 30 where they will contact mass 28 when it nears its limits of movement along the rod. Secondary springs 38 serve a dual purpose: First, they act as travel stops that cushion the mass 28 rather than allowing it to bump against the inside of the case 26, thereby reducing unwanted noise and vibration that would be caused by such an impact. Second, the secondary springs 38 apply a progressive centering force to the mass 28 when it nears the limits of its linear movement along the rod 30, thereby augmenting the coil springs 32 and producing a dual-rate spring effect that improves the energy absorbing performance of the dynamic energy absorbing units 24. Secondary springs 38 preferably have a non-linear spring rate. In the preferred embodiment of the invention shown, the secondary springs 38 are small pads made of neoprene foam material secured to the inner surface of the case 26 with adhesive.

Two or more dynamic energy absorbing units 24 are secured to steering wheel 16 such that the axis of the guide rod 30 of each unit is oriented perpendicular to the radius of the steering shaft 14. Dynamic energy absorbing units 24 are secured to steering wheel 16 by any suitable means, such as threaded fasteners, spring clips, or adhesive. Dynamic energy absorbing units 24 may be attached to steering wheel 16 at any location around the circumference of the wheel, but they are preferably located along a diameter so that guide rods 30 are parallel with one another. For example, in the preferred embodiment dynamic energy absorbing units 24 are attached to spokes 22 at approximately the 3 o'clock and 9 o'clock positions in order to minimize any adverse effect on the balance of the steering wheel 16 throughout its range of rotation. Dynamic energy absorbing units 24 are preferably located as far radially outward on steering wheel 16 as possible, since this allows the lightest possible dynamic energy absorbing units 24 to be used while still achieving the desired vibration dynamic energy absorbing effect.

As steering wheel 16 is subjected to torsional vibration transferred to it through steering shaft 14, the spring/mass systems of the dynamic energy absorbing units 24 are excited and masses 28 oscillate along their respective paths of movement defined by guide rods 30. The path of oscillatory movement of each mass 28 is perpendicular to the radius of steering wheel 16 at its mounting position. This oscillation of the masses 28 results in a partial or complete cancellation of the torsional vibration felt by the driver touching steering wheel 16 as springs 32 absorb the dynamic energy of the moving mass. The weight of masses 28 and the spring constant and pre-load of coil springs 32 are tuned to absorb vibrations of a particular frequency range, as is well known in the art. The masses 28 are able to oscillate out-of-phase with one another if necessary in order to provide optimal vibration absorption.

Torsional vibration experienced by a driver holding the steering wheel 16 may also be reduced by connecting dynamic energy absorbing units 24 according to the present invention to the steering shaft 14 anywhere along its length, not solely at the upper end of the shaft 14 on the steering wheel 16 as described above. For example, dynamic energy absorbing units 24 could be attached to radially projecting spokes or arms (not shown) adjacent a lower end of steering shaft 14 if packaging or other design constraints make it impractical to locate the dynamic energy absorbing units on the steering wheel.

If desired, more than two dynamic energy absorbing units 24 may be attached to the steering wheel 16. This would allow each of the masses 28 to be lighter, and therefore smaller, while still having the desired level of vibration dynamic energy absorbing. Three or more smaller dynamic energy absorbing units 24 may be more practical for a particular steering wheel 16 due to packaging constraints. The dynamic energy absorbing units 24 are preferably located at axially symmetric positions around the circumference of the steering wheel 16 to minimize imbalance.

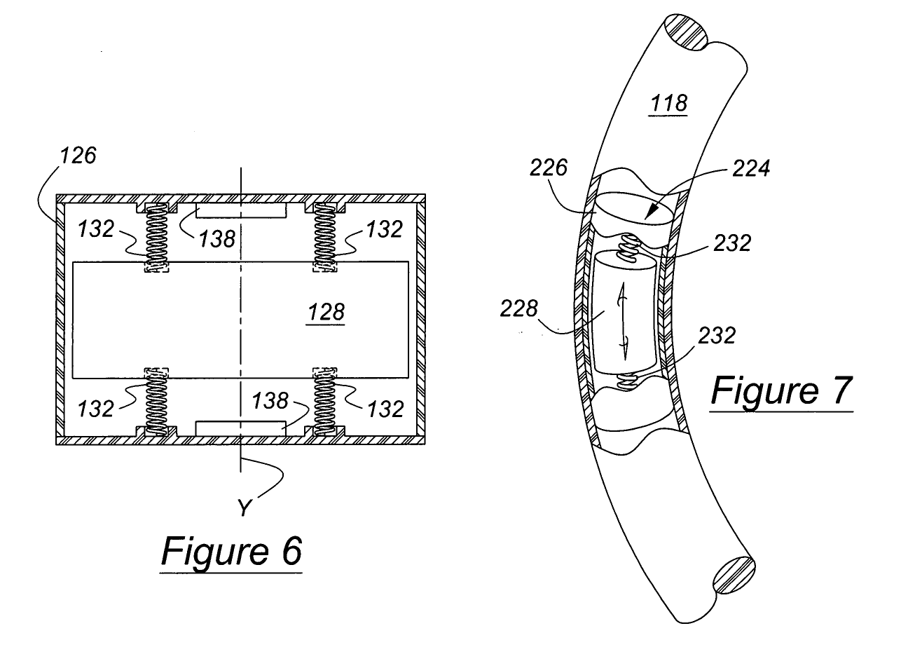

As will be readily apparent to a person of skill in the art, a mechanical unit having the desired dynamic energy absorbing properties may take any number of forms. For example, a second embodiment of a dynamic energy absorbing unit 124 is shown schematically in FIG. 6. Mass 128 is housed within case 126 and is in sliding contact with the inner surfaces of the case for movement along a path parallel with axis y. Two springs 132 are located on either side of mass 128 to provide a centering force on the mass. Secondary springs 138 are positioned on the inner surface of case 126 at opposite ends of the mass's path of movement.

In a third embodiment of the invention shown in FIG. 7, a dynamic energy absorbing unit 224 is integrated with the rim 118 of steering wheel. As with the first disclosed embodiment, two or more units are used on a steering wheel, with the units preferably being located at axially symmetric positions around the circumference of the steering wheel. Each rim-mounted dynamic energy absorbing unit 224 comprises a case 226 having a curvature matching the arc of the circumference of rim 18. A mass 228 is disposed inside of case 226 and is slidable along the length thereof, guided by contact with the interior surface of the case 226. Springs 232 are disposed on either side of mass 228 to center it with respect to the case 226 and thereby provide energy absorption. The path of movement of mass 228 is arcuate, following the circumference of steering wheel rim 118. At any instant of time, however, the mass is moving perpendicular to a radius of the steering wheel rim.

As will be apparent to a person of skill in the art, the present invention may also be practiced using kinetic energy absorption devices other than coil springs. For example, leaf-type springs could be used. Also, a rubber element mounted so that movement of mass 28 loads the rubber in shear may provide the desired dynamic properties. Also, a non-mechanical kinetic absorption device could be used. Examples of such non-mechanical devices are magnetic, electromagnetic, or piezoelectric devices. Any type of dynamic system having a state equation of the form F=k^{a}x may be used.

1. A steering system of an automotive vehicle comprising:
a steering shaft rotatable about an axis to transfer steering commands to a steering gear of the vehicle; and
at least two energy absorbing units mounted to the steering shaft at respective first and second locations radially equidistant from the axis, each energy absorbing unit comprising a mass supported for reciprocal movement along a path of movement oriented such that the mass travels tangentially with respect to a radius of the steering shaft, and at least one kinetic energy absorption device applying a force to return the mass to a neutral position, the mass and kinetic energy absorption device having dynamic characteristics serving to absorb torsional vibrations experienced by the steering shaft.

2. The apparatus according to claim 1 wherein the path of movement of at least one if the masses is a straight line tangential to the steering shaft.

3. The apparatus according to claim 1 wherein the path of movement of at least one if the masses is an arc following a circumference of the steering shaft.

4. The apparatus according to claim 1 wherein the mass is supported for movement along the path of movement by a case secured to the steering shaft and at least partially enclosing the mass.

5. The apparatus according to claim 1 wherein the kinetic energy absorption device comprises first and second coil springs disposed on opposite sides of the mass.

6. The apparatus according to claim 1 further comprising first and second secondary springs disposed on respective first and second opposite sides of the mass along the path of movement, the secondary springs spaced from the mass when in its neutral position by a distance such that the mass contacts the secondary springs when the mass has moved a predetermined distance from the neutral position.

7. The apparatus according to claim 6 wherein at least one of the secondary springs comprises a foam element secured to an interior surface of the case.

8. The apparatus according to claim 1 wherein the steering shaft comprises a steering wheel and the energy absorbing units are attached to the steering wheel.

9. The apparatus according to claim 1 wherein the energy absorbing units are mounted at diametrically opposite locations relative to the steering shaft.

10. The apparatus according to claim 9 wherein the energy absorbing units are mounted at a three o'clock position and a nine o'clock position when the steering shaft is in a neutral position.

11. A steering wheel for an automotive vehicle, the steering wheel having at least two torsional vibration absorbers secured thereto at respective first and second locations equidistant from a rotational axis of the steering wheel, each energy absorbing unit comprising:
a mass;
a guide fixed to the steering wheel and restraining the mass for reciprocal movement along a path of movement tangential to a radius of the steering wheel; and
at least one kinetic energy absorption device applying a force to the mass along the path of movement to return the mass to a neutral position.

12. The apparatus according to claim 11 wherein the path of movement of at least one if the masses is a straight line tangential to the steering wheel.

13. The apparatus according to claim 11 wherein the path of movement of at least one if the masses is an arc following a circumference of the steering wheel.

14. The apparatus according to claim 11 wherein the guide comprises a case secured to the steering wheel and at least partially enclosing the mass and the kinetic energy absorption device.

15. The apparatus according to claim 11 wherein the kinetic energy absorption device comprises first and second coil springs disposed on opposite sides of the mass.

16. The apparatus according to claim 11 wherein the steering wheel has at least a first spoke and a second spoke and the energy absorbing units are mounted on the first and second spokes.

17. The apparatus according to claim 11 wherein the energy absorbing units are mounted on the steering wheel at diametrically opposed locations.

18. The apparatus according to claim 11 further comprising resilient elements disposed on respective first and second opposite sides of the mass along the path of movement, the secondary springs spaced from the mass by a distance such that the mass contacts the secondary springs when the mass has moved a predetermined distance from the neutral position.
